(19) United States
(12) Patent Application Publication
(10) Pub. No.: US 2026/0153339 A1
(43) Pub. Date: Jun. 4, 2026

(54) SYSTEMS AND METHODS FOR AUTONOMOUS DRIVING BASED ON HUMAN- DRIVEN DATA

(71) Applicant: Motional AD LLC, Boston, MA (US)

(72) Inventors: Zhiliang Chen, Singapore (SG); Thomas Kolbaek Jespersen, Singapore (SG); Hans Andersen, Singapore (SG); Scott D. Pendleton, Singapore (SG)

(21) Appl. No.: 19/177,374

(22) Filed: Apr. 11, 2025

Related U.S. Application Data
(63) Continuation of application No. PCT/US2023/076615, filed on Oct. 11, 2023.
(60) Provisional application No. 63/416,371, filed on Oct. 14, 2022.
(60) Provisional application No. 63/477,863, filed on Dec. 30, 2022.

(51) Int. Cl. G01C 21/28

(52) U.S. Cl. CPC G01C 21/28

(57) ABSTRACT

Provided are methods for systems and methods for autonomous driving based on human-driven data, which can include obtaining sensor data associated with an environment in which a vehicle operates, determining a set of candidate trajectories, determining a human-driven trajectory, generating a trajectory score for one or more candidate trajectories of the set of candidate trajectories, and causing an output to be provided to a device based on the trajectory score associated with the one or more candidate trajectories, wherein the output comprises one or more of: the human-driven trajectory, the one or more candidate trajectories, and the one or more trajectory scores. Systems and computer program products are also provided.

### INCORPORATION BY REFERENCE TO ANY PRIORITY APPLICATIONS

This application is a continuation of International Patent Application No. PCT/US2023/076615, filed on Oct. 11, 2023 entitled “SYSTEMS AND METHODS FOR AUTONOMOUS DRIVING BASED ON HUMAN-DRIVEN DATA” which claims the priority benefit of U.S. Patent Prov. App. 63/416,371, entitled SYSTEMS AND METHODS FOR AUTONOMOUS DRIVING BASED ON HUMAN-DRIVEN DATA, filed Oct. 14, 2022, and U.S. Patent Prov. App. 63/477,863, entitled SYSTEMS AND METHODS FOR AUTONOMOUS DRIVING BASED ON HUMAN-DRIVEN DATA, filed Dec. 30, 2022. Each of the above-noted applications is incorporated herein by reference in its entirety.

### BRIEF DESCRIPTION OF THE FIGURES

FIG. 1 is an example environment in which a vehicle including one or more components of an autonomous system can be implemented.

FIG. 2 is a diagram of one or more example systems of a vehicle including an autonomous system.

FIG. 3 is a diagram of components of one or more example devices and/or one or more example systems of FIGS. 1 and 2.

FIG. 4 is a diagram of certain components of an example autonomous system.

FIG. 5A-5B are diagrams of example implementations of processes for systems and methods for autonomous driving based on human-driven data.

FIGS. 6A-B are diagrams of an example vehicle including a planning system and a control system for determination of action.

FIGS. 7A-B are diagrams depicting example determination of actions of example vehicles.

FIG. 8 is a diagram depicting example determination of homotopies.

FIG. 9 is a flowchart of an example process for systems and methods for autonomous driving based on human-driven data.

FIG. 10 is a block diagram of an example planning system of an autonomous vehicle (AV) that can be updated or trained using human-driven data.

FIG. 11 is a flowchart of an example process that can be implemented by the planning system shown in FIG. 10 for updating or training one or more models using human-driven data.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

“At least one,” and “one or more” includes a function being performed by one element, a function being performed by more than one element, e.g., in a distributed fashion, several functions being performed by one element, several functions being performed by several elements, or any combination of the above.”

Some embodiments of the present disclosure are described herein in connection with a threshold. As described herein, satisfying, such as meeting, a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

Autonomous driving systems may generate a plurality of proposal trajectories while driving on roads at any one time. From these proposal trajectories, the autonomous driving system may need to select one trajectory to execute, for example, based on model-based techniques. These techniques typically select a trajectory which is deemed to be “better”. This trajectory selection process is obscure e.g., due to its complexity, and still falls short of providing an autonomous driving system that exhibits a behavior approximating human driving.

In some aspects and/or embodiments, systems, methods, and computer program products described herein include and/or implement obtaining, by at least one processor, sensor data associated with an environment in which a vehicle operates. The method includes determining, by the at least one processor, based on the sensor data, a set of candidate trajectories. The method includes determining, by the at least one processor, based on the sensor data, a human-driven trajectory. The method includes generating, by the at least one processor, based on the human-driven trajectory, a trajectory score for one or more candidate trajectories of the set of candidate trajectories. The method includes causing, by the at least one processor, an output to be provided to a device based on the trajectory score associated with the one or more candidate trajectories. The output includes one or more of: the human-driven trajectory, the one or more candidate trajectories, and the trajectory score.

By virtue of the implementation of systems, methods, and computer program products described herein, techniques for systems and methods for autonomous driving based on human-driven data enable the combination of human driving trajectories with trajectories generated by motion-planning algorithms and/or sampling methods to imitate the trajectory selection process of a human driver. The system is configured to produce a data set indicative of the trajectory selection process (e.g., imitating the process carried out by a human), which can then be used to generate a mathematical model for trajectory selection. This model can then be fitted into autonomous driving systems to allow them to select the best trajectory as close as possible to a human driver.

An approach to generating and selecting a trajectory for an AV to execute included applying relatively inaccurate naive heuristics to the selection process (for example, when designing a cost and/or reward function for the trajectory and/or homotopy selection process). This meant that on occasion, good homotopies were rejected in favor of inferior homotopies, and subsequently inferior trajectories were selected. Advantageously, this disclosure aims at reducing the probability of this scenario occurring by applying a data-driven learning approach to the trajectory selection process. The data-driven learning approach of this disclosure advantageously allows the disclosed techniques to not rely on any heuristic input in the trajectory selection process. Manual design or generation of cost functions and/or reward functions using heuristics for the trajectory selection process can not only result in relatively inaccurate output but is also an extremely time-consuming process. Advantageously, the data-driven method disclosed herein can be carried out by a processor, thus greatly reducing the time required to otherwise tune or carry out the trajectory selection process manually. In other words, the present disclosure advantageously provides a method for selecting trajectories and/or homotopies for a vehicle, based on learned cost functions and/or cost function parameters that approximates the decision-making process of a human driver.

Advantageously, the disclosed method can be applied, by the autonomous system, to other vehicles within “sensor range” of the vehicle. It follows that, in some examples, the autonomous system can obtain data from other human drivers thus providing the AV Compute with more data to learn from. Therefore, a greater volume of human-driven trajectory data can be obtained which enables better and faster optimization of the trajectory scoring cost function.

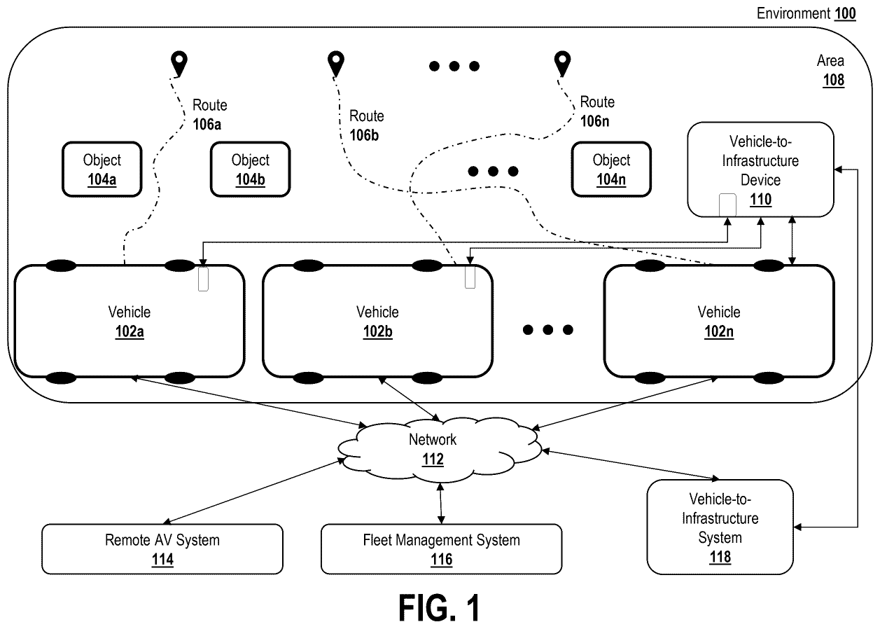

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

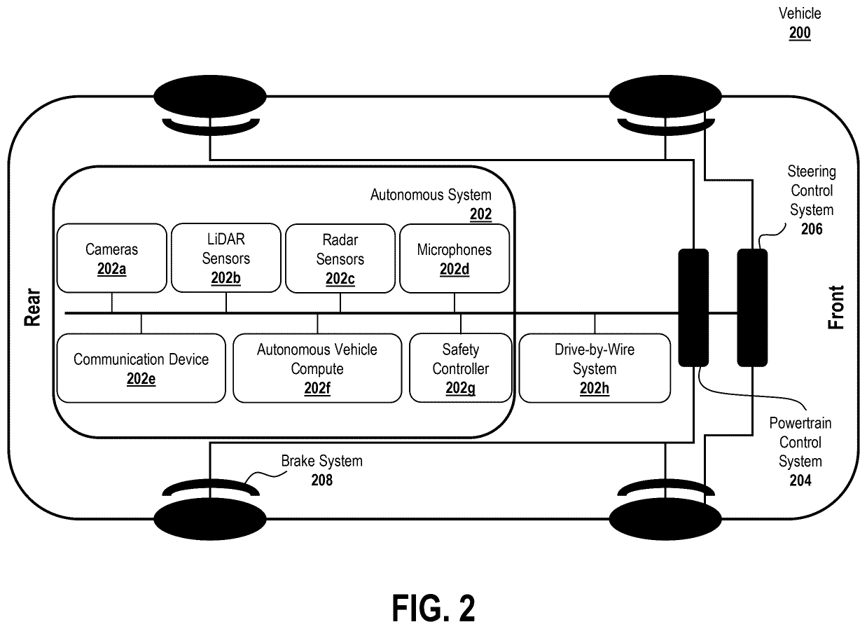

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g., a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high-level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high-level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

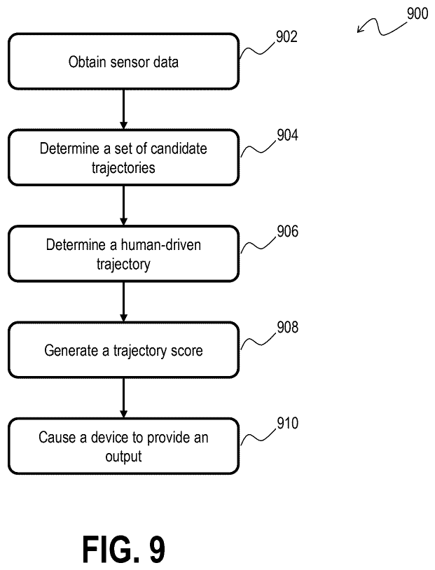

In some embodiments, device 300 is configured to execute software instructions of one or more steps of the disclosed method, as illustrated in FIG. 9.

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicle 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

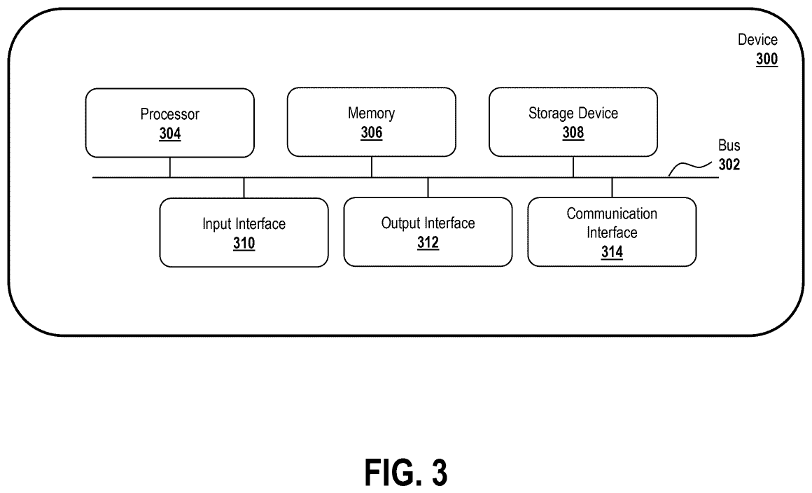

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 make longitudinal vehicle motion, such as to start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate. In other words, steering control system 206 causes activities necessary for the regulation of the y-axis component of vehicle motion.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of remote AV system 114, fleet management system 116, V2I system 118, and/or one or more devices of network 112 (e.g., one or more devices of a system of network 112). In some embodiments, one or more devices of vehicles 102 (e.g., one or more devices of a system of vehicles 102 such as at least one device of remote AV system 114, fleet management system 116, and V2I system 118, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid-state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 306 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

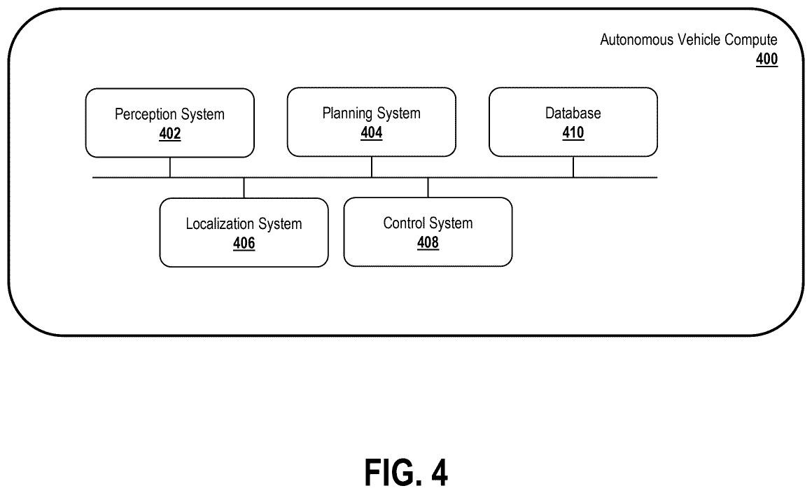

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is provided to, transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

The present disclosure relates to systems, methods, and computer program products that combines human driving decisions with existing planning algorithms to generate a driving data set to replicate the human driving decision-making process. The system for example replicates the trajectory scoring and selection process by leveraging on human driving data and/or existing planning algorithms.

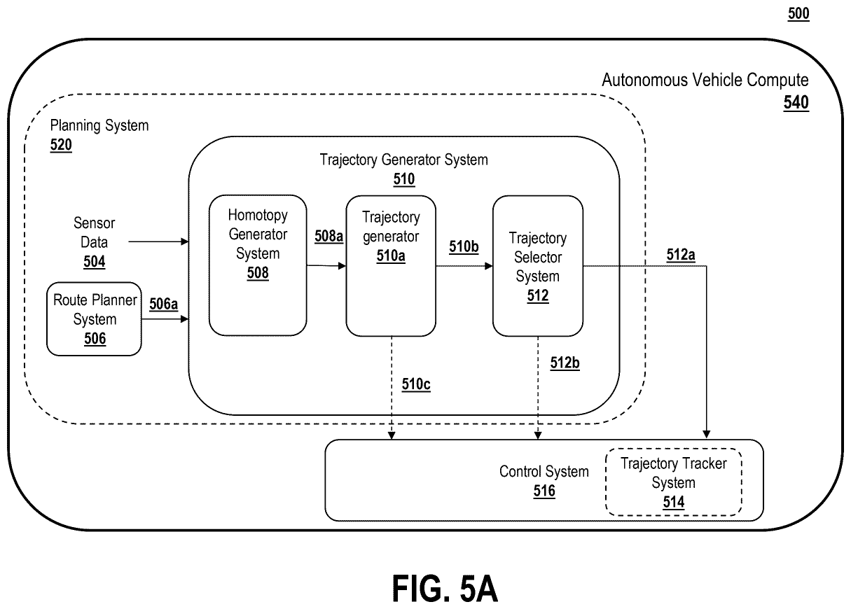

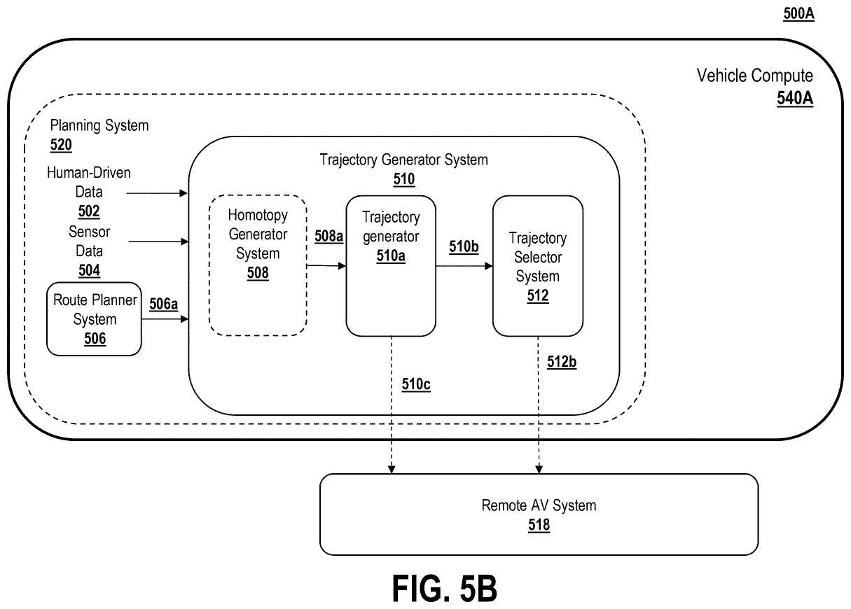

Referring now to FIGS. 5A-5B, illustrated are diagrams of a system 500/500A for systems and methods for autonomous driving based on collected and/or tracked human-driven data. FIG. 5A illustrates an example runtime operation of system 500, e.g., where the system 500 is incorporated in an AV. FIG. 5B illustrates an example training operation, e.g., where the system 500A is connected with and/or incorporated in a vehicle driven by a driver. In some embodiments, system 500/500A is connected with and/or incorporated in a vehicle (e.g., an autonomous vehicle that is the same as, or similar to, vehicle 200 of FIG. 2). In one or more embodiments or examples, system 500/500A is in communication with and/or a part of an AV (e.g., such as Autonomous System 202 illustrated in FIG. 2, device 300 of FIG. 3), an AV system, an AV compute (such as AV compute 202f of FIG. 2 and/or AV compute 400 of FIG. 4), a remote AV system (such as remote AV system 114 of FIG. 1), a fleet management system (such as fleet management system 116 of FIG. 1), and a V2I system (such as V2I system 118 of FIG. 1). The system 500 can be for operating an autonomous vehicle.

Disclosed herein is a system 500/500A. The system 500/500A includes at least one processor. The system 500/500A includes at least one non-transitory readable medium storing instructions that, when executed by the at least one processor, cause the at least one processor to perform operations including obtaining sensor data associated with an environment in which a vehicle operates. The operations include determining, based on the sensor data 504, a set of candidate trajectories. The operations may, e.g. during training and/or runtime as illustrated in FIG. 5A, include determining, based on the sensor data 504, a human-driven trajectory, such as a human-driven trajectory of a vehicle in front of or behind the AV. The operations may, e.g. during training as illustrated in FIG. 5B, include determining, based on the human-driven data 502, a human-driven trajectory. The operations include generating a trajectory score for one or more candidate trajectories of the set of candidate trajectories. The operations include causing an output to be provided to a device based on the trajectory score associated with the one or more candidate trajectories. For example, the device can be the control system, such as control system 408, 516 disclosed herein, and/or any device forming part of the system 500. In one or more embodiments or examples, the output includes one or more of: the human-driven trajectory, the one or more candidate trajectories, and the one or more trajectory scores. For example, the device can be a remote AV system, such as remote AV system 518 or 114 of FIG. 1. The device can be a training device or a database, e.g., used for training one or more models. The system 500A may be used for training or updating one or more of systems 508, 510, 512. In system 500A, a vehicle compute 540A transmits information indicative of the set of candidate trajectories to a remote AV system 518, e.g., AV remote system 114 together with human-driven data 502, such as human-driven trajectory.

In other words, the system 500/500A for example obtains the sensor data which provides information about the environment around the vehicle. For example, the system 500/500A determines, based on the sensor data, potential and/or proposed trajectories, (e.g., a set of candidate trajectories), and a trajectory or trajectories executed by a human driver (e.g., human-driven trajectory/trajectories). The trajectory or trajectories executed by the human driver is for example based on the sensor data that captures and/or shows one or more trajectories driven by human drivers and observed in the environment, such as a human-driven trajectory of a vehicle in front of or behind the AV. For a candidate trajectory, the system 500/500A can generate a trajectory score based on the human-driven trajectory (e.g., to assess how similar the candidate trajectory is to the human-driven trajectory). The system 500/500A then provides as output the human-driven trajectory, the potential and/or proposed trajectories (e.g., one or more candidate trajectories), and/or the trajectory score indicating how similar the potential and/or proposed trajectories are to the human-driven trajectory. The output is for example information that is used to “learn” improved trajectories. The output can be seen as material provided to the disclosed process of generating machine-learning trajectories. In one or more embodiments or examples, the system 500 is configured to control the operation of the vehicle based on the output.

The term “trajectory” disclosed herein can be seen as a path or route to navigate an AV from a first location to a second location. A location can be seen as a spatiotemporal location. The trajectory is for example a lane-level trajectory. In one or more examples, a trajectory includes one or more segments (e.g., sections of road) and each segment includes one or more blocks (e.g., portions of a lane or intersection). In one or more examples, the locations correspond to real world locations.

In one or more embodiments or examples, the system 500 includes an AV compute 540 (e.g., AV compute 400 of FIG. 4, and AV compute 202f of FIG. 4). In one or more embodiments or examples, the system 500A includes a vehicle compute 540A. The system 500/500A includes for example a planning system 520 (e.g., planning system 404 of FIG. 3), optionally a control system 516 (e.g., control system 408 of FIG. 4) and optionally a trajectory tracker system 514. The trajectory tracker system 514 may be embedded or included in control system 516. In one or more embodiments or examples, the system 500/500A includes a route planner system 506, a homotopy generator system 508, and a trajectory generator system 510. In some examples, the planning system 520 includes the route planner system 506, the homotopy generator system 508, the trajectory generator system 510 and optionally a trajectory selector system 512. In some examples, the trajectory generator system 510 includes the homotopy generator system 508, a trajectory generator, and optionally the trajectory selector system 512

In one or more examples, the system 500/500A obtains sensor data 504, such as via the planning system 520. The system 500 for example obtains sensor data 504 via one or more sensors (such as cameras, LiDAR sensors, radar sensors, microphones, and/or a location sensor (such as Global Positioning System, such as Localization System 406 of FIG. 4)), such as cameras 202a, LiDAR sensors 202b, radar sensors 202c, and/or microphones 202d of FIG. 2). In one or more embodiments or examples, the sensor data 504 is one or more of: radar sensor data, non-radar sensor data, camera sensor data, image sensor data, audio sensor, and LIDAR sensor data. The particular type of sensor data 504 is not limiting. The sensor data 504 can be indicative of an environment around an autonomous vehicle. For example, the sensor data 504 can be indicative of one or more objects in the environment near (such as within detectable range of the one or more sensors) an autonomous vehicle. The object can be an object, such as object 104 as illustrated in FIG. 1. An object includes an agent. An agent can be considered any object in the environment capable of dynamic movement. Examples of agents include pedestrians, vehicles, and bicycles. The data, in some examples, represents the agent relative to the environment. The sensor data 504 is optionally indicative of at least one agent being driven by a human driver.

In some examples, the system 500/500A determines the set of candidate trajectories using a planner (such as planning system 520). In some examples, the system 500/500A simulates the exact same scenario as observed via the sensor data (such as the scenario of the human-driven trajectory) and determines candidate trajectories for the same scenario to discern what unseen trajectories a human driver considers internally. The determined candidate trajectories can be considered as unexecuted trajectories a human driver considers in their mind but rejected in favor of the final executed trajectory. In some examples, the candidate trajectories (e.g., potential and/or proposed trajectories) are trajectories determined via the AV compute 540. The candidate trajectories are, in some examples, a set of one or more determined trajectories from which the AV compute 540 and/or the vehicle compute 540A can select one which shall be executed by the AV. In one or more embodiments or examples, the system 500/500A determines, using the trajectory generator system 510, the set of candidate trajectories. In some examples, the information 510b provided from the trajectory generator system 510 to the trajectory selector system 512 includes the set of candidate trajectories. In some examples, information 510c indicative of the set of candidate trajectories and/or human-driven trajectory/trajectories is provided to the control system 516 and/or stored in a database. In some examples, information 510c indicative of the set of candidate trajectories and/or human-driven trajectory/trajectories is provided to a Remote AV system 518 and/or stored in a database.

In one or more embodiments or examples, the system 500/500A determines, based on the sensor data 504, the human-driven trajectory. In one or more embodiments or examples, the system 500A determines, based on human-driven data 502, the human-driven trajectory. The human-driven trajectory is a trajectory which is executed by a human driver. As an example, if a human driver of a vehicle operates a vehicle such that the vehicle turns 90 degrees to the right, the human-driven trajectory is characterized by human-driven data 502 indicative of the vehicle having turned 90 degrees to the right. In some examples, the human-driven data 502 is provided to the homotopy generator system 508. In some examples, the human-driven trajectory is determined using sensor data 504, which can include GNSS data (for example, using the Localization System 406 of FIG. 4). In one or more embodiments or examples, the human-driven trajectory is determined by the trajectory generator system 510 based on the sensor data 504 including human-driven data 502. In some examples, the information 510c provided from the trajectory generator system 510 to the control system 516 includes the human-driven trajectory. In one or more embodiments or examples, the sensor data 504 includes human-driven data 502.

In one or more embodiments or examples, the system 500 generates, based on the human-driven trajectory, the trajectory score for one or more candidate trajectories of the set. The trajectory score can be seen as a score characterizing a similarity between a candidate trajectory and the human-driven trajectory, such as a weight. The trajectory score can be seen as a score characterizing a similarity between the candidate trajectory and the general collection of human-driven trajectories. The trajectory score can be seen as evaluating the replication of the human driving decision making. In some examples, the system 500 generates, based on the human-driven trajectory, the trajectory score for each candidate trajectories of the set. For example, generating the score includes comparing the candidate trajectory and the human-driven trajectory. The trajectory score can be based on the comparison, e.g., based on the difference or similarity. In some examples, the system 500 assigns each of the one or more candidate trajectories with a trajectory score. In other words, a trajectory score can be determined and assigned to each candidate trajectory. In some embodiments or examples, the trajectory score is a scalar value. In some embodiments or examples, the trajectory score is a binary value. In some examples, the trajectory score is calibrated or normalized such that the set of candidate trajectories can be sorted by the system 500 into an order indicative of how similar each candidate trajectory is. In other words, for example, the “best” candidate trajectory is the candidate trajectory most similar to the human-driven trajectory. In some examples, the system 500 identifies, based on the trajectory score, a top scoring trajectory amongst the candidate trajectories. In some examples, the top scoring trajectory is the “best” trajectory (e.g., the candidate trajectory most similar to the human-driven trajectory).

In one or more embodiments or examples, the system 500 causes a device to provide an output based on the trajectory score associated with the one or more candidate trajectories. In one or more embodiments or examples, the system 500 provides the output. In one or more embodiments or examples, the output includes one or more of: the human-driven trajectory, the trajectory score associated with the one or more candidate trajectories, and the one or more corresponding candidate trajectories. In one or more embodiments or examples, the output information 512b provided from the trajectory generator system 510 to the control system 516 includes the output based on the trajectory score associated with the one or more candidate trajectories. In some examples, the information 510c includes the human-driven trajectory, the one or more candidate trajectories, and/or the trajectory score(s). In some examples, the information 510c includes a selected trajectory. In some examples, the system 500 selects, via control system 516 and/or the trajectory selector system 512, a trajectory to execute from the set of candidate trajectories. In one or more embodiments or examples, the information 510b provided from the trajectory generator 510a to the trajectory selector system 512 includes the output based on the trajectory score associated with the one or more candidate trajectories. In some examples, the information 510b includes the one or more candidate trajectories, and/or the trajectory score. In some examples, the trajectory selector system 512 selects, amongst the provided candidate trajectories, a trajectory based on the trajectory scores associated with the provided candidate trajectories. In some examples, the trajectory selector system 512 provides information 512a including the selected trajectory. In some examples, the trajectory selector system 512 provides the information 512a indicative of a selected trajectory to a trajectory tracker system 514. The trajectory tracker system 514 is for example configured to track the AV with respect to the selected trajectory by actuating the throttle, brakes and steering wheel.

In one or more embodiments or examples, determining based on the sensor data 504, the set of candidate trajectories includes generating, based on the sensor data 504, homotopy data indicative of one or more candidate homotopies from a first location to a second location associated with route data. In one or more embodiments or examples, determining the set of candidate trajectories based on the sensor data 504 includes generating the set of candidate trajectories, based on the homotopy data. In one or more embodiments or examples, the set of candidate trajectories is constrained by the one or more candidate homotopies.

A homotopy can be seen as a class describing a set of trajectories, having a same start location and a same end location for which there exists a continuous deformation from one to another while remaining within the class. In other words, a homotopy can be seen as a corridor in space and time. In some examples, a homotopy can be seen as one or more constraints applied to potential trajectories of the vehicle. In some examples these constraints are applied in a 2D space, such as in the x and y coordinate system or along a reference baseline trajectory within a curvilinear coordinate system. In some examples, these constraints are spatio-temporal constraints and/or station-time constraints. In other words, the homotopy can define the set of potential trajectories taking into account the constraints imposed by any obstacle in the environment (e.g., any object). The constraints are for example spatio-temporal in that they constrain the trajectory set in space and time. The constraints are for example station-time constraints in that the constraints take into account the projected location of an obstacle along a reference baseline trajectory at given predicted time instances. Homotopy data can include one or more homotopies. For example, the homotopy data can include a homotopy and one or more constraints (spatio-temporal constraints and/or station-time constraints) associated with the agent and/or obstacle in the environment. In some examples, when a plurality of agents and/or obstacles is present in the environment, the homotopy data (and/or a homotopy of the homotopy data) is determined taking into account each agent and obstacle. In some examples, homotopy data includes the homotopy score. In some embodiments or examples, generating candidate trajectories includes selecting one or more homotopies from a plurality of candidate homotopies. In some examples, candidate homotopies (e.g., potential homotopies and/or proposed homotopies) are homotopies generated by the system 500 via the homotopy generator system 508 of the AV compute 540. In some examples, homotopy data 508a is provided from the homotopy generator system 508 to the trajectory generator system 510. In the example of FIG. 5, the generated trajectories can be based on the candidate homotopies. In one or more embodiments or examples, homotopies can be inferred from candidate trajectories and human-driven trajectories. In one or more embodiments or examples, the sensor data 504 is provided to the homotopy generator system 508.

In one or more embodiments or examples, the system 500 obtains using the at least one processor, route data. In some examples, route data 506a is obtained from the route planner system 506. In some examples, the route data 506a is provided to the homotopy generator system 508. The route data 506a includes, in some examples, information indicative of the route of a vehicle. For example, the route may include information indicative of at least one or more real world locations. In some examples, the route data includes data indicative of a route having a first location (e.g., a start location) and second location (e.g., an end location).

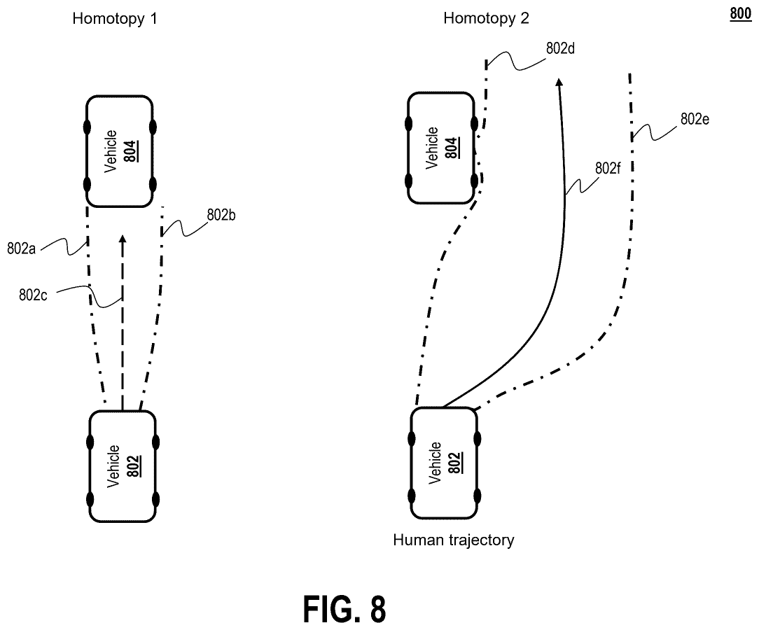

In one or more embodiments or examples, the operations include generating, based on the human-driven trajectory and the trajectory score, a homotopy score for the one or more candidate homotopies. In one or more embodiments or examples, the operations include the homotopy score in the output. In one or more embodiments or examples, the system 500 generates the homotopy score, based on the human-driven trajectory (and/or a collection of human-driven trajectories) and the trajectory score for each candidate homotopy of the one or more candidate homotopies. The homotopy score can be seen as a score (e.g., a weight) evaluating how much of the human-driven trajectory is included in a particular candidate homotopy. For example, a homotopy score for a candidate homotopy may be favorable or high when the candidate homotopy includes the human-driven trajectory to the full extent. In some examples, the homotopy score is assigned to each of the one or more candidate homotopies, e.g., using the AV compute 540. In some examples, the AV compute 540 infers the homotopies (as shown in FIG. 8) with the human-driven trajectory and the candidate trajectory. For example, the AV compute 540 selects or provides a higher score to a homotopy where the human-driven trajectory lie or is located in space and time. In some examples, the homotopy is described by the maneuver options that the ego vehicle may perform with respect to one or more agents. In some examples, the AV compute 540 orders, based on the homotopy score, the set of candidate homotopies, e.g., in increasing or decreasing order. In some examples, the AV compute 540 orders the set of candidate homotopies into an order indicative of how similar a candidate trajectory included in a particular homotopy is to a human-driven trajectory. In some examples, the system 500 assigns each of the one or more candidate homotopies with a homotopy score. In other words, a homotopy score can be determined and assigned to each candidate homotopy. In some embodiments or examples, a homotopy score is a scalar value. In some embodiments or examples, the homotopy score is a binary value. In some examples, the system 500 identifies, based on the homotopy score, a top scoring homotopy amongst the candidate homotopies. In some examples, the top scoring homotopy includes the “best” trajectory (e.g., the candidate homotopy including the candidate trajectory most similar to the human-driven trajectory). For example, the system 500 updates a model (e.g., a mathematical model) able to provide which homotopies are the most optimal in any one or more given scenarios. In one or more embodiments or examples, the homotopy score is generated for the one or more candidate homotopies via the homotopy generator system 508. In one or more embodiments or examples, the homotopy generator system 508 provides homotopy data 508a to the trajectory generator system 510. The homotopy data 508a includes for example one or more homotopies, e.g., one or more of the ordered homotopies, and optionally their corresponding homotopy scores.

In one or more embodiments or examples, the operations of the system 500 include constructing one or more trajectory scoring cost functions based on the homotopy score. In one or more embodiments or examples, the operations include updating a trajectory scoring model based on the one or more trajectory scoring cost functions. In some examples, the trajectory scoring cost function is a cost function and/or a reward function for scoring the one or more candidate trajectories, e.g., used in the training objective function during training. The one or more trajectory scoring cost functions optionally includes one or more of a comfort cost function, an acceleration violation cost function, a Collision Energy Transfer cost function, a trajectory blockage cost function, a driven distance cost function, a lane change violation cost function, and an obstacle clearance cost function.

In some examples, the trajectory scoring cost function is used to order the candidate trajectories, choosing one of the candidate trajectories, such as the most performant trajectory. In some examples, the update can be performed continuously and/or periodically and/or triggered by an event. As disclosed herein, candidate trajectories are for example sorted by the system 500 into an order using the trajectory scoring cost function. It may be appreciated that a human chooses usually just one candidate trajectory because a human doesn't normally have a pool of alternatives innately, so the other trajectories are not even known. For an autonomous vehicle, the process leading to a selected trajectory is much more involved as disclosed herein. In some examples, the system 500 provides one or more scores. The score can be seen as a confidence value associated with a trajectory. In other words, for example, confidence can be seen as a value that the network learns, recognizing that the network has seen this trajectory more and so it is more confident to choose it as the best one. In some examples, the scores do not have probabilistic meaning associated to them.

In some examples, the system 500 updates the trajectory scoring model based on the one or more trajectory cost scoring functions. For example, the trajectory scoring model includes the trajectory scoring cost functions. In some examples, the trajectory scoring model assigns a trajectory score to each of the one or more candidate trajectories. In some examples, the trajectory generator system 510, such as the trajectory selector system 512, is configured to operate according to the trajectory scoring model.

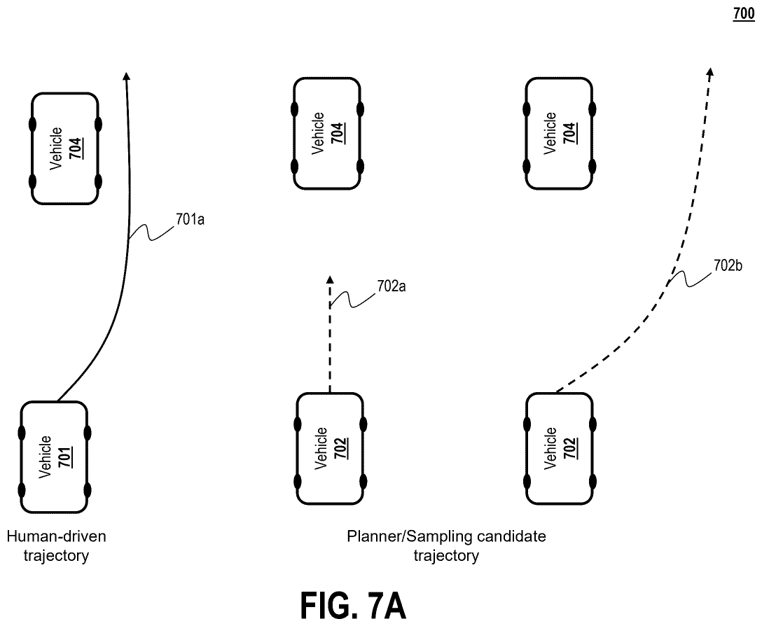

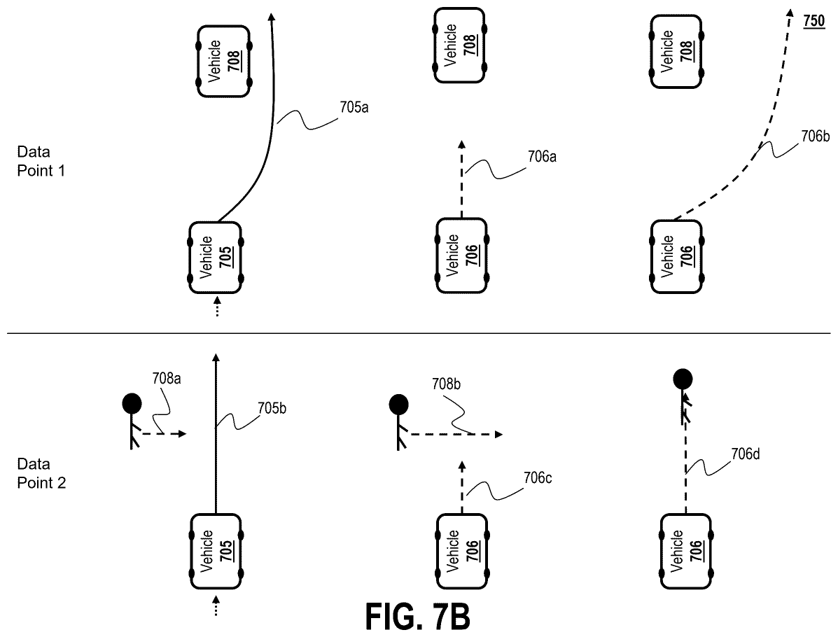

In one or more embodiments or examples, the system 500 constructs, via a data set (such as a data set including the two human-driven trajectories in Data Points 1 and 2 of FIG. 7B) a trajectory scoring cost function which reflects the human decision making and preference from the data. In some examples, the trajectory scoring cost function undergoes an update process. In some examples, the system 500 constructs the trajectory scoring cost function using one or more machine learning models. In some examples, the machine learning method used is imitation learning. In some embodiments or examples, the updating and/or learning process can not only be optimized using machine learning models but could also be updated via online learning methods as more data is continuously obtained, thus improving the cost structure across time. For example the online learning methods include the AV compute 540 communicating with a network for model updates. The model updates can include updates to the selector model, homotopy model, and/or the trajectory scoring model. In some examples, the online learning methods include improving the trajectory scoring cost functions, e.g., using a Bayesian method. In one or more embodiments or examples, the system 500 carries out the updates via the online learning methods when the vehicle is stationary (such as when the vehicle is charging and/or parked).

In one or more embodiments or examples, the system 500 selects, based on the output, a trajectory and/or a future trajectory, such as via the selector model. In one or more embodiments or examples, the system 500 selects, based on the one or more candidate trajectories and/or the corresponding trajectory scores, a trajectory and/or a future trajectory, such as via the selector model. In one or more embodiments or examples, the system 500 selects a trajectory and/or a future trajectory, such as via the selector model, based on the one or more candidate trajectories, the corresponding trajectory scores, and/or the human-driven trajectory. In one or more embodiments or examples, the operations of the system 500 include updating, based on the output, a selector model for selecting a future trajectory from a set of future candidate trajectories. In some examples, the selector model is a selector function configured to select a present trajectory and/or a future trajectory. In some examples, the selector model is updated while the vehicle is not in use. For example, the selector model may be updated while the vehicle is charging. The selector model is, in some examples, updated by transmitting and receiving data from a network (such as network 112 of FIG. 1). In some examples, a fleet of AVs, such as a plurality of communicatively coupled AVs, may be in communication with the network. In some embodiments or examples, the updated selector model is stored on the network and uploaded to one or more vehicles in the fleet. In some examples, the selector model is stored in a database of the autonomous vehicle (such as database 410 of AV compute 400 as shown in FIG. 4). In some examples, the selector model is stored in a server, that is for example remotely located, such as a cloud server. In one or more embodiments or examples, the trajectory selector system 512 is configured to operate according to the selector model.

In one or more embodiments or examples, the system 500 selects, using the at least one processor, a future trajectory via the selector model. For example, the future trajectory is a trajectory that the AV compute 540 will generate at some point in the future, such as the next trajectory during runtime. In other words, the future trajectory is a trajectory that has yet to be generated. In some examples, the future trajectory is a trajectory that has yet to be executed by the vehicle. In one or more embodiments or examples, the system 500 selects the future trajectory, using the at least one processor, from a set of future candidate trajectories. In some examples, the set of future candidate trajectories are candidate trajectories that have yet to be generated (such as using the trajectory generator system 510). In other words, the future trajectory can be seen as a selected future candidate trajectory.

In one or more embodiments or examples, updating the selector model includes updating, based on the output, a homotopy model for generating and/or selecting one or more future homotopies. In one or more embodiments or examples, the system 500 generates and/or selects the one or more future homotopies via the homotopy model. In some examples, the selector model includes one or more homotopy models. In some examples, the homotopy model generates a homotopy score for the one or more candidate homotopies. In one or more embodiments or examples, the homotopy generator system 508 includes the homotopy model. In some examples, future homotopies are homotopies that the AV compute will generate at some point in the future. In other words, the future homotopies are homotopies that have yet to be generated.

In one or more embodiments or examples, the operations further include selecting, based on the homotopy model, one or more future homotopies. In one or more embodiments or examples, the system 500 can be configured such that the one or more sensors obtain sensor data 504 indicative of the trajectory of other vehicles (e.g., agents) in the environment. In other words, the system 500 can be configured to detect or track, e.g., via the sensor data 504, other vehicles with human drivers on the road and use them as data points. In some examples, the system switches the perspective of the disclosed AV (so called “ego” vehicle) with the role of one of the agents driven by a human such that the agent driven by a human can be used to gather further human-driven trajectories. In some examples, “ego” vehicle is the vehicle for which trajectories and/or homotopies are generated using system 500. This switching of perspective can be called a data augmentation. In some examples, the system 500 can generate trajectories and/or homotopies for a plurality of vehicles simultaneously. This can enable a greater volume of trajectory data to be obtained. In some examples, this trajectory data is used to construct the trajectory scoring cost function. In some examples, the ego vehicle is stationary while “tracking” vehicles in the environment. In some examples, the ego vehicle is moving while “tracking” vehicles in the environment.

In some embodiments or examples, the system 500 can be configured to incorporate, using the at least one processor, some heuristics to discern which scenario should be considered when collecting human-driven data 502. For example, scenarios including more interactions with other agents (such as vehicles, pedestrians, trees, etc.) are taken into account since drivers in these scenarios are likely to have more candidate trajectories in their head when making decisions. This can enable the system 500 to propose more trajectories using the planning system 520 and can result in richer data sets.

In one or more embodiments or examples, the system 500 is in communication with one or more of: a device (such as device 300 of FIG. 3), a localization system (such as localization system 406 of FIG. 4), a planning system (such as the planning system 404 of FIG. 4 or planning system 520 of FIG. 5), a perception system (such as the perception system 402 of FIG. 4), and a control system (such as the control system 408 of FIG. 4).

To control the operation can include to generate control data (e.g., leading to a control signal) for a control system of an autonomous vehicle. To control the operation can include to provide control data to a control system of an autonomous vehicle. To control the operation can include to transmit control data to, e.g., a control system of an autonomous vehicle and/or an external system. To control the operation can include to control, based on control data, a control system of an autonomous vehicle and/or an external system.

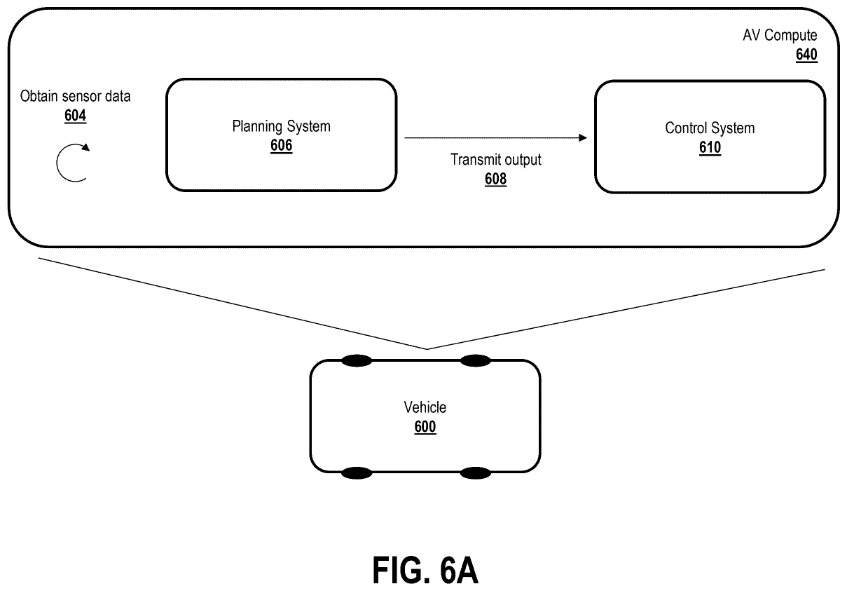

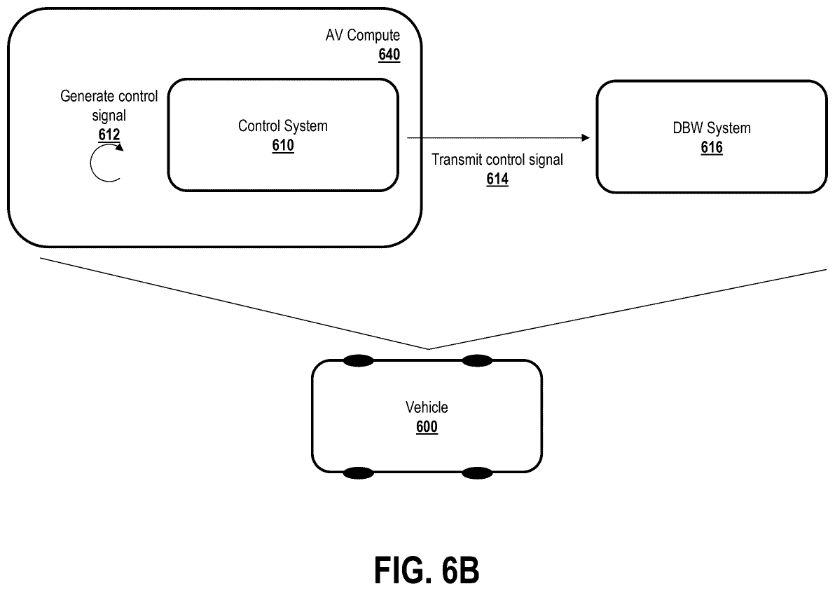

Referring now to FIGS. 6A and 6B, diagrams of an example vehicle 600 including a planning system and a control system for determination of action are shown. The vehicle 600 includes an AV compute 640.

In the example of FIG. 6A, AV compute 640 includes a planning system 606 (such as the planning system 520 of FIG. 5) and a control system 610 (such as control system 516 of FIG. 5). In FIG. 6A the AV compute 640 can continuously obtain sensor data 604 indicative of the environment of the vehicle 600. The sensor data 604 is then inputted into the planning system 606 for generating an output that can be used to provide a trajectory. The output 608 provided and/or transmitted from the planning system 606 to the control system 610 can be the same as, or similar to, the information 512a of FIG. 5A.

In the example of FIG. 6B, the AV compute 640 includes the control system 610 (such as the control system 516 of FIG. 5 and the control system 610 of FIG. 6A) and a Drive-By-Wire (DBW) system 616. The AV compute 640, for example, continuously generates a control signal 612. In some examples, the control signal is transmitted 614 to the DBW system 616. For example, the control signal includes information indicative of instructions for executing a selected trajectory. In some examples, the DBW system 616 operates the vehicle 600 according to the selected trajectory. For example, the control signal is based on the output 608. The device disclosed herein which provides the output 608 can be the AV compute 640 and/or the control system 610.

Referring now to FIGS. 7A and 7B, diagrams 700, 750 depicting example determination of actions of example vehicles are shown. The example of FIG. 7A shows a particular scenario where the disclosed technique is applied, e.g., in a pipeline to imitate human decision-making process. The disclosed technique provides, in one or more embodiments, data including one or more human driven trajectories and planner-proposed trajectories (e.g., one or more candidate trajectories and/or one or more selected trajectories). In the example of FIG. 7A, the vehicle 702 (including e.g., the AV compute 400 of FIG. 4, the AV compute 540 of FIG. 5 and/or the AV compute 640 of FIGS. 6A and 6B) can be configured to obtain the human-driven trajectory 701a. The human-driven trajectory 701a is, for example, performed by a first vehicle 701. FIG. 7A shows the disclosed vehicle 702, such as an AV (such as the vehicle 102 of FIG. 1, the vehicle 200 of FIG. 2, vehicle including system 500 of FIG. 5 and the vehicle 600 of FIGS. 6A and 6B). FIG. 7A shows an agent (in this example, a second vehicle 704) positioned directly ahead of the first vehicle 701, (such as in the direction of motion of the first vehicle 701), therefore an acceleration in one or more directions is required to avoid a collision. In some examples, the first vehicle 701 performs the human-driven trajectory 701a which circumvents the second vehicle 704. In other words, the vehicle 702 can observe, via sensor data, the human-driven trajectory carried out by vehicle 701. In some examples, the vehicle 702 determines a first candidate trajectory 702a and a second candidate trajectory 702b. Candidate trajectory 702a is a candidate trajectory including no lateral acceleration. Candidate trajectory 702b is a candidate trajectory, generated by the AV compute, including lateral acceleration. The vehicle 702, by applying the disclosed technique, determines that the trajectory score of 702b is more favorable than the trajectory score of 702a. 702b is more similar to 701a than 702a. It can be noted that candidate trajectory 702b includes a wider detour around the second vehicle 704 compared to the detour of the human-driven trajectory 701a, however 702b remains closer to 701a than 702a. In some examples, candidate trajectories 702a, 702b are trajectories that a driver may consider internally, which are then rejected in favor of the final executed trajectory (e.g., human-driven trajectory 701a).

FIG. 7B shows data points from two different example scenarios. The data points may form part of the output disclosed herein. The first scenario includes Data Point 1 which can correspond with the example shown in FIG. 7A. The second scenario includes Data Point 2. A first vehicle 705 of FIG. 7B can be the same as the first vehicle 701 of FIG. 7A. A second vehicle 708 of FIG. 7B can be the same as the second vehicle 704 of FIG. 7A. The trajectories 705a, 706a, and 706b can be the same as trajectories 701a, 702a, and 702b of FIG. 7A. Data Point 1 is, in some examples, a data point provided to a machine learning method. In some examples, information indicative of Data Point 1 is included in a machine learning model.

In one or more embodiments or examples, the trajectory scoring cost function is based on one or more human-driven trajectories, such as the human-driven trajectory 705a. For example, the trajectory scoring cost function is trained by candidate trajectories 706a and 706b compared to their similarity with the human-driven trajectory 705a. In other words, the trajectory score assigned to each candidate trajectory 706a, 706b can be indicative of its similarity to the human-driven trajectory 705a. In some examples, the candidate trajectories 706a, 706b most similar to the human-driven trajectory 705a is assigned the most performant score. In some examples, the most performant score can be the highest or the lowest score. For example, constructing the trajectory scoring cost function can include determining which candidate trajectory is the most performant trajectory. In other words, constructing the trajectory scoring cost function can be based on one or more data points, such as the Data Point 1.

The second scenario (such as the scenario indicative of Data Point 2) also includes the first vehicle 705. The second scenario includes an external trajectory, such as trajectory 708a and 708b. In some examples, this external trajectory is indicative of an external object moving through the environment. In the example of Data Point 2, the external object moving through the environment is a pedestrian. The pedestrian of FIG. 7B is in the vicinity of a plurality of trajectories of the vehicle 706. The external object can be any object present in the environment (e.g., a vehicle, a pedestrian, a tree, etc.). In some examples, the trajectory of this external object is detected by one or more sensors of vehicle 706 (such as cameras 202a, LiDAR Sensors 202b, radar sensors 202c, and/or microphones 202d) and then determined by the AV compute. The example of Data Point 2 includes a human-driven trajectory 705b and candidate trajectories 706c and 706d (such as generated by the AV compute). In the examples of human-driven trajectory 705b and candidate trajectory 706c, a collision is avoided. In the example of candidate trajectory 706d, a collision may occur.

In one or more embodiments or examples, the trajectory scoring cost function is applied using one or more human-driven trajectories, such as the human-driven trajectory 705b. For example, the candidate trajectories 706c and 706d are scored according to their similarity with the human-driven trajectory 705b. In other words, the trajectory score and/or weight assigned to each candidate trajectory 706c and 706d can be indicative of its similarity to the human-driven trajectory 705b. In some examples, the candidate trajectory 706c and 706d most similar to the human-driven trajectory 705b is assigned the most performant score. In some examples, the most performant score is the lowest score. In some examples, the most performant score is the highest score. For example, constructing the trajectory scoring cost function can include determining which candidate trajectory is the most optimal trajectory. In other words, constructing the trajectory scoring cost function can be based on one or more data points, such as the Data Point 2.

Referring now to FIG. 8, a diagram 800 depicting example determination of homotopies is shown. FIG. 8 shows a first vehicle 802 and a second vehicle 804. A second vehicle 804 of FIG. 8 can be the same as the second vehicle 704 of FIG. 7A and/or the second vehicle 708 of FIG. 7B. Illustrated is Homotopy 1 which includes homotopy borders 802a and 802b and the candidate trajectory 802c. Also illustrated is Homotopy 2 which includes homotopy borders 802d and 802e and the human-driven trajectory 802f. Specifically, the FIG. 8 illustrates an example where homotopy borders can be inferred from trajectories (such as candidate trajectory 802c and/or human-driven trajectory 802f) by the AV Compute. In this example, because the human-driven trajectory 802f was performed by a human driver as opposed to the candidate trajectory 802c, the AV Compute can then infer that the homotopy 2 is better because it contains the human-driven trajectory. In other words, the “best” homotopy can include the human-driven trajectory, such as human-driven trajectory 802f. Therefore, of the homotopies illustrated in FIG. 8, homotopy 2 would, in some examples, be selected by a model (such as by a homotopy model and/or a selector model) as the “best” homotopy or most performant. In the example illustrated in FIG. 8, the system (such as the system 500 of FIG. 5) can be configured to learn (for example via a machine learning model) a model to order a set of homotopies (such as the homotopies 1 and 2 of FIG. 8) into an order indicative of which homotopy is “best” or most performant. In one or more embodiments or examples, the system (such as the system 500 of FIG. 5) is configured to determine a single “best” homotopy.

Referring now to FIG. 9, illustrated is a flowchart of a method or process 900 for systems and methods for autonomous driving based on human-driven data, such as for operating and/or controlling an AV. The method can be performed by a system disclosed herein, such as one or more of: an AV compute 202f of FIG. 2 and AV compute 400 of FIG. 4, a vehicle 102, 200, of FIGS. 1 and 2, respectively, device 300 of FIG. 3, system 500 and AV compute 540 of FIG. 5A, system 500A and vehicle compute 540A of FIG. 5B, and implementations of FIGS. 6A-6B, 7A-7B and 8. The system disclosed can include at least one processor which can be configured to carry out one or more of the operations of method 900. The method 900 can be performed (e.g., completely, partially, and/or the like) by another device or group of devices separate from or including system disclosed herein.

A method is disclosed. The method 900 includes obtaining, at step 902, by at least one processor, sensor data associated with an environment in which a vehicle operates. The method 900 includes determining, at step 904, by the at least one processor, based on the sensor data, a set of candidate trajectories. In some examples, the determining the set of trajectories includes using a planner. The method 900 includes determining, at step 906, by the at least one processor, e.g., based on the sensor data, a human-driven trajectory (for example, an executed trajectory by a human driver). The method 900 includes generating, at step 908, by the at least one processor, based on the human-driven trajectory, a trajectory score for one or more candidate trajectories of the set of candidate trajectories. The method 900 includes causing, at step 910, by the at least one processor, an output to be provided to a device based on the trajectory score associated with the one or more candidate trajectories. In one or more embodiments or examples, the output includes one or more of: the human-driven trajectory, the one or more candidate trajectories, and the one or more trajectory scores. In some examples, the system (such as system 500 of FIG. 5A and/or system 500A of FIG. 5B) determines the set of candidate trajectories using a planner (such as planning system 520 of FIGS. 5A and/or 5B). In some examples, the planner uses predictions coming from the perception system 402 as a result of the sensor data and determines candidate ego trajectories for the same scenario to discern what unexecuted trajectories a human driver considered internally. The determined candidate trajectories can be considered as unexecuted trajectories a human driver considered in their mind but rejected in favor of the final executed trajectory. In some examples, the human-driven trajectory is a trajectory which is executed by a human driver. The trajectory score can be seen as a score characterizing a similarity between a candidate trajectory and the human-driven trajectory, such as a weight. For example, generating the score includes comparing the candidate trajectory and the human-driven trajectory. The trajectory score can be based on the comparison, e.g., based on the difference or similarity. The trajectory score can be seen as evaluating the replication of the human driving decision making. In some embodiments or examples, the trajectory score is a scalar value. In some embodiments or examples, the trajectory score is a binary value. The method 900 includes causing an output to be provided, the output including the human-driven trajectory, the one or more candidate trajectories, and the trajectory score. The output is for example information that is used to “learn” improved trajectories. The output can be seen as material provided to the disclosed process of generating machine-learning trajectories, such as for training homotopy and/or trajectory generator system. In one or more embodiments or examples, the system 500 is configured to control the operation of the vehicle based on the output.

In one or more embodiments or examples, determining, at step 904, based on the sensor data, the set of candidate trajectories includes generating, based on the sensor data, homotopy data indicative of one or more candidate homotopies from a first location to a second location associated with route data. In one or more embodiments or examples, determining, at step 904 based on the sensor data, the set of candidate trajectories includes generating, by the at least one processor, based on the homotopy data, the set of candidate trajectories. In one or more embodiments or examples, the set of candidate trajectories are constrained by the one or more candidate homotopies. In some examples, route data is obtained from a route planner system (such as route planner system 506 of FIG. 5). The homotopy data can include one or more homotopies. For example, the homotopy data includes a homotopy and one or more constraints (spatio-temporal constraints and/or station-time constraints) associated with the agent in the environment. In some examples these constraints are applied in a 2D space, such as in the x and y coordinate system. In some examples, when a plurality of agents are present in the environment, the homotopy data (and/or a homotopy of the homotopy data) is determined taking into account each agent. In some embodiments or examples, generating candidate trajectories includes selecting one or more homotopies from a plurality of candidate homotopies.

In one or more embodiments or examples, the method 900 includes generating, by the at least one processor, based on the human-driven trajectory and the trajectory score, a homotopy score for the one or more candidate homotopies. In one or more embodiments or examples, the method 900 includes, by the at least one processor, the homotopy score in the output. In one or more embodiments or examples, generating the homotopy score includes generating the homotopy score based on the human-driven trajectory and the trajectory score for each candidate homotopy of the one or more candidate homotopies. The homotopy score can be seen as a score (e.g., a weight) evaluating how much of the human-driven trajectory is included in a particular candidate homotopy. For example, a homotopy score for a candidate homotopy may be favorable or high when the candidate homotopy includes the human-driven trajectory. In some examples, the homotopy score is assigned to each of the one or more candidate homotopies, e.g., using the AV compute disclosed herein. In some examples, the system infers the homotopies (as shown in FIG. 8) having a higher homotopy score based on the homotopies including the human-driven trajectory. In some examples, the homotopy is described by the maneuver options that the ego vehicle may perform with respect to one or more agents. In some examples, the AV compute orders, based on the homotopy score, the set of candidate homotopies, e.g., in increasing or decreasing order. In some examples, the method 900 includes ordering the set of candidate homotopies into an order indicative of how similar a candidate trajectory included in a particular homotopy is to a human-driven trajectory. In some examples, the method 900 includes assigning each of the one or more candidate homotopies with a homotopy score. In other words, a homotopy score can be determined and assigned to each candidate homotopy. In some embodiments or examples, a homotopy score is a scalar value. In some embodiments or examples, the homotopy score is a binary value. In some examples, the method 900 includes identifying, based on the homotopy score, a top scoring homotopy amongst the candidate homotopies. In some examples, the top scoring homotopy includes the “best” trajectory (e.g., the candidate homotopy including the candidate trajectory most similar to the human-driven trajectory.

In one or more embodiments or examples, the method 900 includes updating, by the at least one processor, based on the output, a selector model selecting a future trajectory from a set of future candidate trajectories, e.g., during future runtime of the AV. In some examples, the future trajectory is a trajectory that has yet to be generated. In some examples, the selector model is a selector function configured to select a present trajectory and/or a future trajectory.

In one or more embodiments or examples, updating the selector model includes updating, based on the output, a homotopy model for generating and/or selecting one or more future homotopies. In some examples, the homotopy model generates a homotopy score for the one or more candidate homotopies. In some examples, future homotopies are homotopies that have yet to be generated, e.g., during future runtime of the AV.

In one or more embodiments or examples, the method 900 further includes selecting, by the at least one processor, based on the homotopy model, one or more future homotopies.

In one or more embodiments or examples, the method 900 further includes constructing, by the at least one processor, one or more trajectory scoring cost functions based on the homotopy score. In one or more embodiments or examples, the method 900 further includes updating, by the at least one processor, a trajectory scoring model based on the one or more trajectory scoring cost functions. In some examples, the trajectory scoring cost function is a cost function and/or a reward function for scoring the one or more candidate trajectories. In some examples, the trajectory scoring cost function is used to order the candidate trajectories, choosing one of the candidate trajectories, such as the most performant trajectory. For example, the trajectory scoring model includes the trajectory scoring cost functions. In some examples, the trajectory scoring model assigns a trajectory score to each of the one or more candidate trajectories. It may be appreciated that a human chooses usually just one candidate trajectory because a human doesn't normally have a pool of alternatives innately, so the other trajectories are not even known. In some examples, the system (such as system 500 of FIG. 5) provides one or more weights. The weight can be seen as a confidence value associated with a trajectory. In other words, for example, confidence can be seen as a value that the network learns, recognizing that the network has seen this trajectory more and so it is more confident to choose it as the best one. In some examples, the weights do not have probabilistic meaning associated with them. In one or more embodiments or examples, the system (such as system 500 of FIG. 5A and/or system 500A of FIG. 5B) constructs, via a data set (such as a data set including Data Points 1 and 2 of FIG. 8), a trajectory scoring cost function which reflects the human decision making and preference from the data. In some examples, the method 900 includes constructing the trajectory scoring cost function using one or more machine learning models. In some embodiments or examples, the updating and/or learning process can not only be optimized using machine learning models but could also be updated via online learning methods as more data is continuously obtained, thus improving the cost structure and thereby the decision-making process across time.

### Example Planning System With Training Pipeline

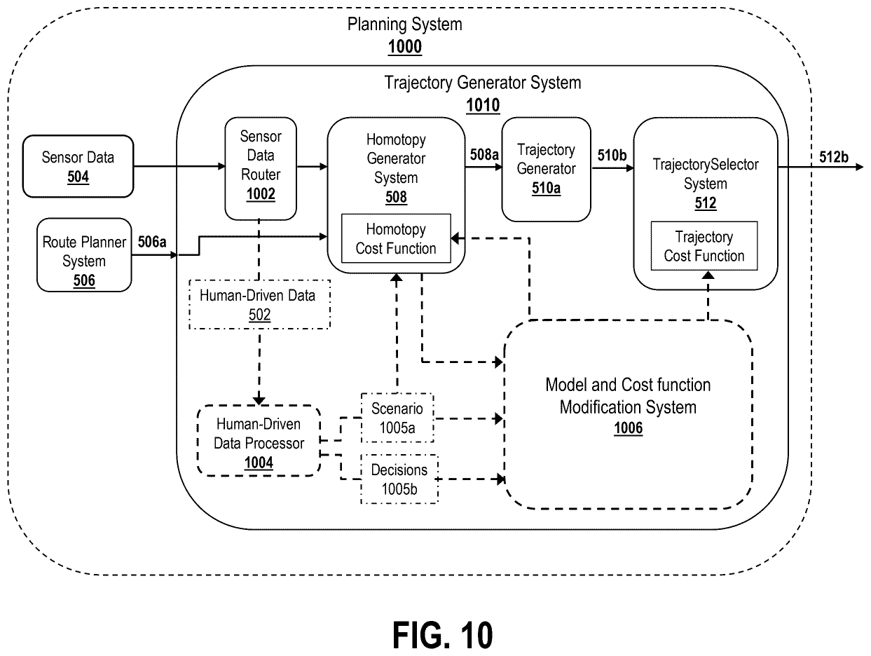

FIG. 10 is a block diagram of an example planning system 1000 of an autonomous vehicle (AV) that can be updated or trained using human-driven data 502. In some cases, human-driven data 502 can be included in sensor data 504. In some cases, human-driven data 502 can be associated with the trajectories selected by a driver (a human driver) of an AV (the ego vehicle) or other vehicles that have been monitored by the sensor for sufficient amount of time to generate data usable for the training process. Additionally, in some cases, human driven-data may include a barrier or an external trajectory (e.g., external trajectory 708a or 708b) defining a scenario associated with a trajectory selected by a human driver. For example, human driven data may include Data Point 1 or Data Point 2 described above with respect to FIG. 7B.

In some embodiments, in addition to a control pipeline used to generate trajectories during autonomous control of the AV, the planning system 1000 may include modules and processes for implementing a training pipeline configured for training and/or updating one or more models or algorithms based on human-drive data. In some cases, the training pipeline can be implemented during a training period to update one or both a homotopy cost function used by the homotopy generator system 508 and a trajectory cost function used by the trajectory selector system 512. In some cases, the trajectory cost function can be a trajectory scoring cost function that may be used to generate a score for a trajectory. In some cases, the homotopy cost function can be a homotopy scoring cost function that may be used to generate a score for a homotopy.

In some cases, the planning system 1000 may include a trajectory generator system 1010 and a route planner system 506. In some cases, the planning system 1000 and the trajectory generator system 1010, may comprise one or more features described above with respect to the planning system 520 and/or the trajectory system 510. In some cases, the operation of the planning system 1000 and the trajectory system 1010, may comprise one or more features described above with respect to the operation of the planning system 520 and the trajectory generator system 510.

Similar to the trajectory generator system 510, the trajectory generator system 1010 may include a homotopy generator system 508, a trajectory generator 510a, and/or a trajectory selector system 512. In some cases, the homotopy generator 508 system uses the sensor data 504 and the routes received from the route planner system 506 to generate homotopy data 508a comprising homotopies (corridors) 508a through which the AV can navigate from an initial location to a second location. In some cases, the homotopy generator 508 system may use a homotopy cost function to generate scores for a plurality of homotopies generated based on the sensor data 504 and information received from the route planner system 506 and include homotopies that satisfy a threshold score (e.g., scores above the threshold score) in the homotopy data 508a.

In some cases, the sensor data 504 is received from a sensor (e.g., a LiDAR, Radar, or a camera) or a localization system of the AV (e.g., the Localization System 406 of FIG. 4). In some embodiments, the sensor data 504 can include human-driven data 502 associated with the ego vehicle when driven by a human, or data associated with other vehicles that are driven by a human. In some cases, the sensor data 504 can include GNSS data (for example, received from the Localization System 406).

In some cases, the trajectory generator 510a uses the homotopy data 508a received from the homotopy generator system 508 and generates information 510b (e.g., trajectory data) comprising one or more of candidate trajectories. In some cases, one or more trajectories may fall within the same homotopy however the trajectory generator 510a generates one trajectory realization for an individual homotopy included in the homotopy data 508a. As such, in some cases, there is a one-to-one mapping between trajectory realizations and their corresponding homotopy. In some cases, it may not be possible to generate a trajectory for a homotopy; in these cases, the homotopy may be marked as infeasible. In some cases, trajectory selector system 512 receives the information 510b (trajectory data) from the trajectory generator 510a and selects a trajectory that will be output by the planning system 1000, as output information 512b usable by a control system of the AV (e.g., the control system 516) to autonomously control the AV). In some cases, the trajectory selector system 512 may use a trajectory cost function to generate scores for a plurality of trajectories generated by the trajectory generator 510a and selects a trajectory that satisfies a score threshold (e.g., trajectory having a highest score or trajectory with a score above a particular score threshold) to be included in the output information 512b. In some cases, the homotopy generator system 508 and the trajectory selector system 512, may use models (e.g., machine learning models) to select homotopies and trajectories.

In some implementations, the planning system 1000 may be used in a control mode, to generate output information 512b by processing real-time sensor data 504 via a control pipeline and use the output information 512b to control the AV. In some cases, the control pipeline comprises the route planner system 506, the homotopy generator system 508, the trajectory generator 510a, and the trajectory selector system 512. In some cases, the route planner system 506 may generate route data 506a based at least in part the sensor data 504. In some examples, the route data 506a can include data indicative of a route having a first location (e.g., a start location or origin) and second location (e.g., an end location or destination). In some cases, route planner system 506 may generate the route data 506a based on one or more obstacles, and/or one or more roads (or streets) connecting the first and the second locations.

In some implementations, the planning system 1000 may be used in a training mode, to optimize, update, and/or train a model, a cost function, or an algorithm used by the planning system 1000 to generate output information 512b using sensor data 504. In some cases, the training mode may comprise manual control of the AV by a driver. In some cases, in the training mode the planning system 1000 uses previously collected sensor data 504 collected during a manual driving session where the AV was controlled by a driver. In some cases, previously collected sensor data 504 may comprise data associated with the ego vehicle or other vehicles monitored by a sensor system of the ego vehicle (the AV). In some cases, previously collected sensor data 504 may comprise data associated with other vehicles monitored by a sensor system of the ego vehicle (the AV) when the ego vehicle was autonomously controlled. For example, the sensor system may monitor how vehicles in the environment of the ego vehicle navigate through the environment and store the trajectories and/or paths of the monitored vehicles.

In some cases, a model, an algorithm, or a cost function may be optimized, updated, and/or trained for one or more driving scenarios. In some examples, a driving scenario (also referred to as scenario) may include navigating the AV from an initial location to a second location. Additionally, in some examples, a driving scenario may include navigating the AV in the presence of one or more obstacles or constraints that can affect a route from the initial location to the destination. As such, in some cases, the model, the cost function, or the algorithm will be optimized, updated, and/or trained for specific scenarios and will be used to autonomously control the AV, in a control mode, for other instances of the corresponding scenarios.

In some cases, the planning system 1000 may be operated in a training mode at predefined periods and/or based on an amount of sensor data 504 collected during one or more manual driving sessions. In some cases, when the models, cost functions, or algorithms of the planning system 1000 have been already trained or updated for a scenario, additional data collected for the same scenario may not be used for further training or may not trigger another training mode for that scenario.

In some cases, a training mode can be selected or triggered manually by (e.g., a user, a system engineer, or a driver), prior to a manual driving session where the AV is controlled by a driver. In these cases, the planning system 1000 may be loaded with a software configured for data collection and training. In some cases, by default the AV is controlled autonomously and a manual driving is specifically performed for training the system for a particular scenario. In some cases, during a manual driving session, the planning system 1000 may be loaded with a software configured for data collection to collect human-driven data associated with driving the ego vehicle. The collected human-driven data may be used for training the system offline.

In some cases, during an offline training session (when the training mode is activated), the trajectory generator system 1010 may receive previously collected or logged data and search in the logged data to find where flags indicate the data was collected during a manual driving session and uses the data associated with manual driving session for training.

In some implementations, the trajectory generator system 1010 may include a sensor data router 1002 that allows the planning system 1000 and/or a user, driver, or system engineer, to selectively route the sensor data 504 to a control pipeline or a training pipeline. In some cases, selecting or activating a control mode causes the sensor data router 1002 to transmit the sensor data 504 to the homotopy generator system 508 and activates the control pipeline. In some cases, selecting or activating a training mode causes the sensor data router 1002 to transmit the sensor data 504 to a human-driven data processor 1004 and activates the training pipeline. In some cases, the planning system 1000 may automatically determine that the AV is driven by a human driver and in response to such determination, activate the training mode. In some cases, the sensor data router 1002 may comprise a smart router configured to identify human-driven data. In these cases, the sensor data router 1002 may use certain indicators to identify human-driven data and upon such identification, redirect the data to the training pipeline to train and/or update a cost function, a model, or software.

In some implementations, the training pipeline comprises the human-driven data processor 1004, a model and cost function modification system 1006, the homotopy generator 508 system, the trajectory generator 510a, and the trajectory selector system 512. In some cases, human-driven data processor 1004 may be configured to use human-driven data 502 received from the sensor data router 1002 to determine a scenario 1005a associated with the human-driven data 502 and decisions 1005b made by the driver with respect to the determined scenario 1005a, e.g., a trajectory selected by the human driver to navigate the AV in the determined scenario 1005a. In some cases, human-driven data processor 1004 may comprise a route planner system 506 or algorithm that generates the scenario 1005a based at least on the sensor data 504. In some cases, the human-driven data processor 1004 may be in communication with the route planner system 506, and use the route planner system 506 to generate the scenario 1005a. In some cases, the scenario 1005a may include route data extracted from the human-driven data 502. In some cases, the scenario can be indicative of a route having a first location (e.g., a start location) and second location (e.g., an end location). In some cases, human-driven data processor 1004 may generate the scenario 1005a based on one or more barriers, and/or one or more roads (or streets) connecting the first and the second locations. In some cases, in a training mode, the trajectory generator system 1010 may use the homotopy generator system 508 to generate one or more homotopies and transmit the one or more homotopies to the model and cost function modification system 1006. The model and cost function modification system 1006 may be configured to receive the scenario 1005a, the decisions 1005b, and the homotopies corresponding to the scenario (generated by the homotopy generator system 508) and update a model or a cost function. In the example shown in FIG. 10, the model and cost function modification system 1006 updates and/or trains a homotopy cost function (e.g., homotopy scoring cost function) used by the homotopy generator system 508 and a trajectory cost function (e.g., a trajectory scoring cost function) used by the trajectory generator system 512. The cost functions trained or updated during a training period (when planning system 1000 is operated in a training mode), may be used during a control mode where the AV is autonomously controlled to navigate in a scenario for which the cost functions have been updated or trained. Advantageously, using human-driven data for updating or training cost function may improve the accuracy of the homotopies selected by the homotopy generator system 508 and the trajectory selector system 512. In some cases, a trajectory cost function generated or modified by the model and cost function modification system 1006 assigns higher scores to trajectories closer to human-driven trajectories. In some cases, a homotopy cost function generated or modified by the model and cost function modification system 1006 assigns higher scores to homotropies that include a human-driven trajectory. In some cases, a trajectory score and/or weight assigned to a trajectory (e.g., a candidate trajectory), can be indicative of its similarity to a human-driven trajectory.

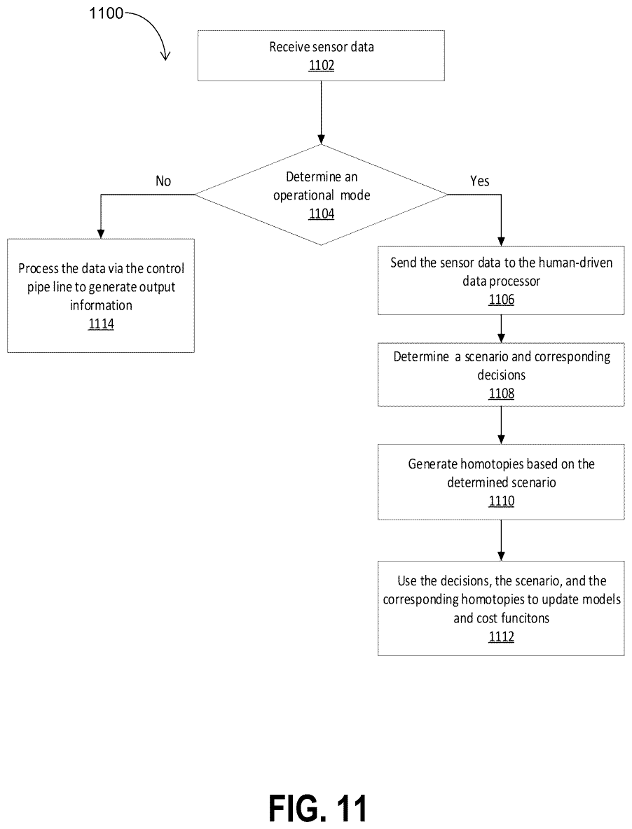

FIG. 11 is a flowchart of an example process 1100 that can be implemented by the planning system shown in FIG. 10 for updating or training one or more models (e.g., scoring models), algorithms, or cost functions using human-driven data. In some cases, the process 1100 may be performed by a hardware processor of the planning system 1000.

The process 1100 begins at block 1102 where the planning system 1000 receives sensor data 504 from a sensor (e.g., a camera, a LiDAR, a radar, or other sensors) of an autonomous vehicle (AV). In some cases, the sensor data 504 may additionally comprise data received from other systems of the AV, where the data is indicative of a location of the AV or actions taken by a human driver that manually drives the AV.

At decision block 1104 the planning system 1000 may determine an operational mode of the planning system 1000. In some cases, the operational mode may have been selected by a driver, a user, or a technician. In some cases, determining an operational mode by the planning system 1000 may comprise selecting an operational mode by the planning system 1000 based at least in part the sensor data 504. For example, upon detecting a flag or an indicator in the sensor data 504, the planning system 1000 may determine that sensor data 504 includes human-driven data and in response, select the training mode.

If at the decision block 1104 the planning system 1000 determines that the training mode has been selected or selects the training mode based on the sensor data 504, the process moves to block 1106 where the planning system 1000 transmits the human-driven data 502 to the human-driven data processor 1004.

At block 1108 the planning system 1000 uses the human-driven data processor 1004 to determine a scenario 1005a and the decisions 1005b made by the human driver in response to driving the AV in the determined scenario, as described herein. In some cases, the decisions 1005b may comprise a trajectory selected by the driver.

At block 1110 the planning system 1000 transmits the scenario 1005a to the homotopy generator system 508 to generate homotopies associated with the determined scenario. In some cases, the scenario may comprise route data.

At block 1112 the planning system 1000 uses the model and cost function modification system 1006 to update one or more models, algorithms, or cost functions, based on the decisions and the scenario generated by the human-driven data process 1004 (at block 1108), and the homotopies generated by the homotopy generator system 508 (at block 1112). For example, the planning system 1000 may update or train a homotopy cost function used by the homotopy generator system 508 by comparing the homotopies generated using the scenario 1005a and a trajectory selected by the human driver in the scenario 1005a. As another example, the planning system 1000 may update or train a trajectory cost function (e.g., a trajectory scoring cost function), e.g., by comparing the trajectories generated by the trajectory generator 510a for homotopies determined for the scenario 1005a, and the trajectory selected by the human driver in the scenario 1005a.

If at the decision block 1104 the planning system 1000 determines that the control mode has been selected or selects the control mode based on the sensor data 504, the process moves to block 1114 where the planning system 1000 process the sensor data 504 through the control pipeline to generate output information 512b and transmits the output information 512b to the control system 516.

### Example Embodiments

Example embodiments described herein have several features, no single one of which is indispensable or solely responsible for their desirable attributes. A variety of example systems and methods are provided below.

Also disclosed are methods, non-transitory computer readable media, and systems according to any of the following items:

Example 1. A method comprising:
obtaining, by at least one processor, sensor data associated with an environment in which a vehicle operates;
determining, by the at least one processor, a set of candidate trajectories based on the sensor data;
determining, by the at least one processor, a human-driven trajectory based on the sensor data;
generating, by the at least one processor, a trajectory score for one or more candidate trajectories of the set of candidate trajectories, based on the human-driven trajectory; and
causing, by the at least one processor, an output to be provided to a device based on the trajectory score associated with the one or more candidate trajectories, wherein the output comprises one or more of: the human-driven trajectory, the one or more candidate trajectories, and the one or more trajectory scores.

Example 2. The method of Example 1, wherein determining the set of candidate trajectories based on the sensor data, comprises:
Generating homotopy data indicative of one or more candidate homotopies from a first location to a second location associated with route data, based on the sensor data; and
generating, by the at least one processor, the set of candidate trajectories based on the homotopy data, wherein the set of candidate trajectories are constrained by the one or more candidate homotopies.

Example 3. The method of any of the previous Examples, the method comprising: generating, by the at least one processor a homotopy score for the one or more candidate homotopies based on the human-driven trajectory and the trajectory score; and including, by the at least one processor, the homotopy score in the output.

Example 4. The method of any of the previous Examples, the method comprising updating, by the at least one processor, a selector model for selecting a future trajectory from a set of future candidate trajectories, based on the output.

Example 5. The method of Example 4, wherein updating the selector model comprises updating a homotopy model for generating and/or selecting one or more future homotopies based on the output.

Example 6. The method of Example 5, further comprising selecting, by the at least one processor one or more future homotopies based on the homotopy model.

Example 7. The method of any of the previous Examples, further comprising:
constructing, by the at least one processor, one or more trajectory scoring cost functions based on the homotopy score; and
updating, by the at least one processor, a trajectory scoring model based on the one or more trajectory scoring cost functions.

Example 8. A system comprising:
at least one processor; and
at least one non-transitory computer readable medium storing instructions that, when executed by the at least one processor, cause the at least one processor to perform operations comprising:
obtaining sensor data associated with an environment in which a vehicle operates;
determining a set of candidate trajectories based on the sensor data;
determining a human-driven trajectory based on the sensor data;
generating a trajectory score for one or more candidate trajectories of the set of candidate trajectories based on the human-driven trajectory; and
causing an output to be provided to a device based on the trajectory score associated with the one or more candidate trajectories, wherein the output comprises one or more of: the human-driven trajectory, the one or more candidate trajectories, and the one or more trajectory scores.

Example 9. The system of Example 8, wherein determining based on the sensor data, the set of candidate trajectories comprises:
generating, based on the sensor data, homotopy data indicative of one or more candidate homotopies from a first location to a second location associated with route data; and
generating, based on the homotopy data, the set of candidate trajectories, wherein the set of candidate trajectories are constrained by the one or more candidate homotopies.

Example 10. The system of any of Examples 8-9, the operations comprising:
Generating a homotopy score for the one or more candidate homotopies based on the human-driven trajectory and the trajectory score; and
including the homotopy score in the output.

Example 11. The system of any of Examples 8-10, the operations comprising updating, based on the output, a selector model for selecting a future trajectory from a set of future candidate trajectories.

Example 12. The system of Example 11, wherein updating the selector model comprises updating a homotopy model for generating and/or selecting one or more future homotopies based on the output.

Example 13. The system of Example 12, the operations further comprising selecting one or more future homotopies based on the homotopy model.

Example 14. The system of any of Examples 8-13, the operations further comprising:
constructing one or more trajectory scoring cost functions based on the homotopy score; and
updating a trajectory scoring model based on the one or more trajectory scoring cost functions.

Example 15. A non-transitory computer readable medium comprising instructions stored thereon that, when executed by at least one processor, cause the at least one processor to carry out operations comprising:
obtaining sensor data associated with an environment in which a vehicle operates;
determining a set of candidate trajectories based on the sensor data;
determining a human-driven trajectory based on the sensor data;
generating a trajectory score for one or more candidate trajectories of the set of candidate trajectories based on the human-driven trajectory; and
causing an output to be provided to a device based on the trajectory score associated with the one or more candidate trajectories, wherein the output comprises one or more of: the human-driven trajectory, the one or more candidate trajectories, and the one or more trajectory scores.

Example 16. The non-transitory computer readable medium of Example 15, wherein determining the set of candidate trajectories based on the sensor data comprises:
generating, based on the sensor data, homotopy data indicative of one or more candidate homotopies from a first location to a second location associated with route data; and
generating the set of candidate trajectories based on the homotopy data, wherein the set of candidate trajectories are constrained by the one or more candidate homotopies.

Example 17. The non-transitory computer readable medium of any of Examples 15-16, the non-transitory computer readable medium comprising:
generating, based on the human-driven trajectory and the trajectory score, a homotopy score for the one or more candidate homotopies; and
including, the homotopy score in the output.

Example 18. The non-transitory computer readable medium of any of items 15-17, the non-transitory computer readable medium comprising updating, based on the output, a selector model for selecting a future trajectory from a set of future candidate trajectories.

Example 19. The non-transitory computer readable medium of Example 18, wherein updating the selector model comprises updating, based on the output, a homotopy model for generating and/or selecting one or more future homotopies.

Example 20. The non-transitory computer readable medium of Example 19, the non-transitory computer readable medium further comprising selecting, based on the homotopy model, one or more future homotopies.

Example 21. The non-transitory computer readable medium of any of Examples 15-20, the non-transitory computer readable medium further comprising:
constructing, one or more trajectory scoring cost functions based on the homotopy score; and
   updating, a trajectory scoring model based on the one or more trajectory scoring cost functions.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step and/or sub-entity of a previously recited step or entity.

Disclosed are non-transitory computer readable media comprising instructions stored thereon that, when executed by at least one processor, cause the at least one processor to carry out operations according to one or more of the methods disclosed herein.

What is claimed is:

1. A method comprising:
obtaining, by at least one processor, sensor data associated with an environment in which a vehicle operates;
determining, by the at least one processor, a set of candidate trajectories based on the sensor data;
determining, by the at least one processor, a human-driven trajectory based on the sensor data;
generating, by the at least one processor, a trajectory score for one or more candidate trajectories of the set of candidate trajectories, based on the human-driven trajectory; and
causing, by the at least one processor, an output to be provided to a device based on the trajectory score generated for the one or more candidate trajectories of the set of candidate trajectories, wherein the output comprises one or more of: the human-driven trajectory, the set of candidate trajectories, and the trajectory score.

2. The method of claim 1, wherein determining the set of candidate trajectories based on the sensor data comprises:
generating, based on the sensor data, homotopy data indicative of one or more candidate homotopies from a first location to a second location associated with route data; and
generating, by the at least one processor, the set of candidate trajectories based on the homotopy data, wherein the set of candidate trajectories is constrained by the one or more candidate homotopies.

3. The method of claim 2, further comprising:
generating, by the at least one processor, based on the human-driven trajectory and the trajectory score, a homotopy score for the one or more candidate homotopies; and
including, by the at least one processor, the homotopy score in the output.

4. The method of claim 1, the method comprising updating, by the at least one processor, a selector model for selecting a future trajectory from a set of future candidate trajectories, based on the output.

5. The method of claim 4, wherein updating the selector model comprises updating, a homotopy model for generating and/or selecting one or more future homotopies based on the output.

6. The method of claim 5, further comprising selecting, by the at least one processor one or more future homotopies based on the homotopy model.

7. The method of claim 3, further comprising:
constructing, by the at least one processor, one or more trajectory scoring cost functions based on the homotopy score; and
updating, by the at least one processor, a trajectory scoring model based on the one or more trajectory scoring cost functions.

8. A system comprising:
at least one processor; and
at least one non-transitory computer readable medium storing instructions that, when executed by the at least one processor, cause the at least one processor to perform operations comprising:
obtaining sensor data associated with an environment in which a vehicle operates;
determining, a set of candidate trajectories based on the sensor data;
determining, a human-driven trajectory based on the sensor data;
generating, a trajectory score for one or more candidate trajectories of the set of candidate trajectories based on the human-driven trajectory; and
causing an output to be provided to a device, based on the trajectory score generated for the one or more candidate trajectories, wherein the output comprises one or more of: the human-driven trajectory, the one or more candidate trajectories, and the trajectory score.

9. The system of claim 8, wherein determining the set of candidate trajectories based on the sensor data comprises:
generating, homotopy data indicative of one or more candidate homotopies from a first location to a second location associated with route data based on the sensor data; and
generating, the set of candidate trajectories based on the homotopy data, wherein the set of candidate trajectories are constrained by the one or more candidate homotopies.

10. The system of claim 9, the operations comprising:
generating, based on the human-driven trajectory and the trajectory score, a homotopy score for the one or more candidate homotopies; and
including the homotopy score in the output.

11. The system of claim 8, the operations comprising updating a selector model for selecting a future trajectory from a set of future candidate trajectories based on the output.

12. The system of claim 11, wherein updating the selector model comprises updating a homotopy model for generating and/or selecting one or more future homotopies based on the output.

13. The system of claim 12, the operations further comprising selecting, one or more future homotopies based on the homotopy model.

14. The system of claim 10, the operations further comprising:
constructing one or more trajectory scoring cost functions based on the homotopy score; and
updating a trajectory scoring model based on the one or more trajectory scoring cost functions.

15. A non-transitory computer readable medium comprising instructions stored thereon that, when executed by at least one processor, cause the at least one processor to carry out operations comprising:
obtaining sensor data associated with an environment in which a vehicle operates;
determining a set of candidate trajectories based on the sensor data;
determining a human-driven trajectory based on the sensor data;
generating a trajectory score for one or more candidate trajectories of the set of candidate trajectories based on the human-driven trajectory; and
causing an output to be provided based on the trajectory score generated for the one or more candidate trajectories, wherein the output comprises one or more of: the human-driven trajectory, the one or more candidate trajectories, and the trajectory score.

16. The non-transitory computer readable medium of claim 15, wherein determining the set of candidate trajectories based on the sensor data comprises:
generating homotopy data indicative of one or more candidate homotopies from a first location to a second location associated with route data, based on the sensor data; and
generating the set of candidate trajectories based on the homotopy data, wherein the set of candidate trajectories are constrained by the one or more candidate homotopies.

17. The non-transitory computer readable medium of claim 16, the non-transitory computer readable medium comprising:
generating a homotopy score for the one or more candidate homotopies, based on the human-driven trajectory and the trajectory score; and
including, the homotopy score in the output.

18. The non-transitory computer readable medium of claim 15, the non-transitory computer readable medium comprising updating a selector model based on the output, for selecting a future trajectory from a set of future candidate trajectories.

19. The non-transitory computer readable medium of claim 18, wherein updating the selector model comprises updating a homotopy model for generating and/or selecting one or more future homotopies, based on the output.

20. The non-transitory computer readable medium of claim 19, the non-transitory computer readable medium further comprising selecting one or more future homotopies, based on the homotopy model.
